(19) United States
(12) Patent Application Publication
(10) Pub. No.: US 2017/0278141 A1
(43) Pub. Date: Sep. 28, 2017

(54) Menu Advertising System

(71) Applicants: Ruslan Kipnis, San Diego, CA (US); Michael Sosinsky, San Diego, CA (US)

(72) Inventors: Ruslan Kipnis, San Diego, CA (US); Michael Sosinsky, San Diego, CA (US)

(21) Appl. No.: 15/466,776

(22) Filed: Mar. 22, 2017

Related U.S. Application Data
(60) Provisional application No. 62/311,790, filed on Mar. 22, 2016.

(51) Int. Cl. G06Q 30/02; G06F 3/0482; G06Q 30/06; G06F 17/30; G06Q 50/12

(52) U.S. Cl. CPC G06Q 30/0269; G06F 17/30876; G06Q 50/12; G06Q 30/0635; G06F 3/0482

(57) ABSTRACT

An Menu Advertising system is disclosed which presents menu items to a user and that allows a user to input menu selections in connection with making purchases while using an electronic device. In connection with inputting user characteristics gleaned from a history of user purchase history, menu selection, demographic data, etc., menu items may be tailor to a particular user or what's determined to be a particular type of user. In addition, advertisements may be presented to a user during the user interaction with the electronic device. The advertisement may be a video or a number of still images presented in accordance with analytic data determined from prior purchases and an volunteered information from the user.

### CROSS-REFERENCE TO RELATED APPLICATIONS

The present application claims priority to U.S. Provisional Patent Application No. 62/311,790 filed on Mar. 22, 2016, entitled “Menu Advertising System,” the entire disclosure of which is incorporated by reference herein.

### BACKGROUND OF THE INVENTION

1. Field of Invention

The present invention relates to the field of electronic menu advertising, and in particular, characterizing diners to provide targeted advertising.

2. Description of Related Art

Menus are typically used at restaurant locations to display a list of food choices for patrons. Menus may be mounted above the counter, or given to diners. Electronic menus are used more frequently, wherein a patron selects one or more menu items, wherein the items are immediately ordered from the kitchen, or ordered after authentication by a wait staff.

The electronic menus in particular take display options and take orders easily, but there is no capacity for suggesting further choices. In particular, there is no option of third-party advertising in electronic menus. Therefore, there is a need for a system in electronic menus that suggests further choices and/or permits third party advertising. Further, a system that tracks users and their historical choices enables customizing the menu display to make the choices most attractive to the particular customer.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a functional view of the menu advertising system, according to an embodiment of the present invention.

FIG. 2 is a functional view of the menu advertising system according to an embodiment of the present invention.

FIG. 3 is a diagram which further illustrates an embodiment outlining the customer interaction and display options available on an interactive device such as a tablet

FIG. 4 illustrate the promotional aspects including screen shots of the menu advertising system, according to an embodiment of the present invention.

### DETAILED DESCRIPTION OF PREFERRED EMBODIMENTS

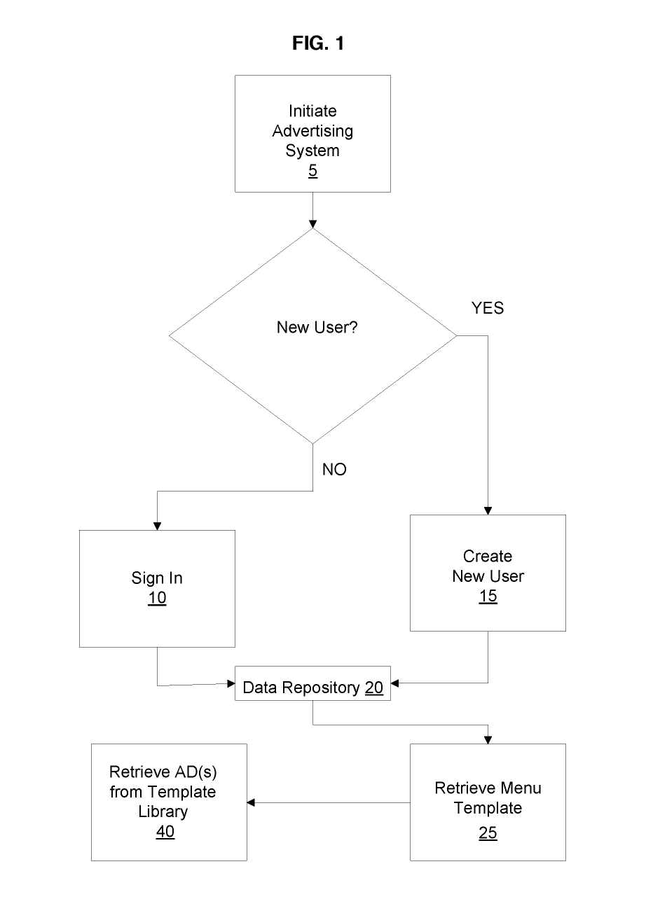

Preferred embodiments of the present invention and their advantages may be understood by referring to FIGS. 1-4, wherein like reference numerals refer to like elements.

In one embodiment, ads are displayed on a mobile device which is used to view menus for selection of items and to conduct purchases. FIG. 1 illustrates a flowchart summarizing the flow of device use as described herein. With reference to FIG. 1, at step 5 the menu advertising system is initiated by touching the screen or powering the device on. In step 10, the user signs in, and signs in to a different portal depending on whether they are a user or a restaurant. If the user does not exist, at step 15 a new user is created. In step 20, for a new user, the data repository is initiated, and for an existing user the repository is accessed. In step 25 a menu template for the establishment is retrieved from a template library, and in step 30 the template is rearranged according to prior purchase or interest history from the repository. In step 40, one or more ads are retrieved from an ad library, wherein the ads may comprise text and/or images, and in step 45, the menu is displayed to the user along with ads positioned within the template. In some embodiments data relating to customer preferences, prior purchase history, customer demographic data, etc. is held remote from the device. Such data may be accessed using Bluetooth™ (Bluetooth Low Energy (LE)), Wi-Fi, wireless area network, etc. in establishing a communication link with the mobile device. The mobile device may be a mobile phone, electronic tablet, etc., preferably having the capability for wireless communications connectivity. Alternatively, all or some part of the stored data relating to a user can be stored locally on the mobile device in one or more memories resident with the mobile device.

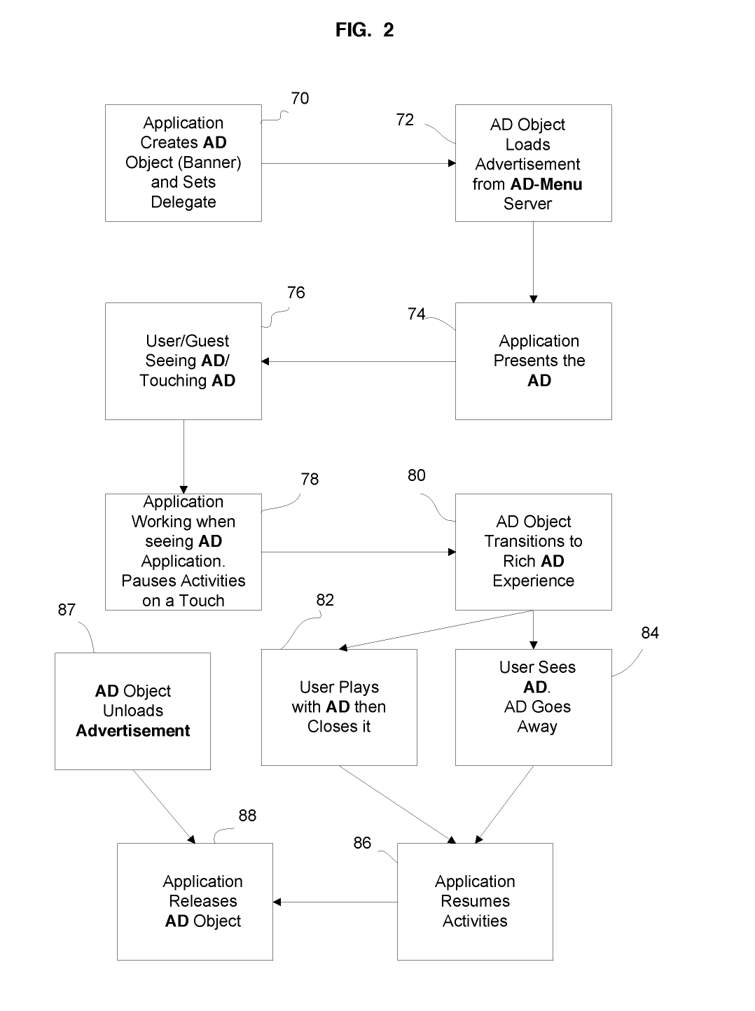

An advertising concept in accordance with some embodiments is shown in the flowchart of FIG. 2. In step 70, an application creates an object called AD which may be a single screen presentation (banner-which can be indicated across the top of a displayed page) or a video and it sets its delegate (regarding software delegation pattern). In step 72, the AD object loads an advertisement from the AD-Menu server (holding or controlling the advertisement). At step 74, the application causes presentation of the advertisement (which shall be referred to herein, with reference to FIG. 2, as simply “AD,” being the result of AD object). The user/guest, using an interface, may observe the AD at step 76 and the user may also interactively respond to the AD. At step 78, the application may pause activities in connection with an interface such as the touch screen of a phone or tablet. At step 80, the AD object transitions to a rich AD experience. At this step, a more comprehensive advertisement may run. Past step 80, the user may play with the interactive advertisement and close it (Step 82) or the user may view the AD after which the AD ceases to run (Step 84). At Step 86, the application resumes its activity. The application unloads the advertisement at Step 87 and it releases the AD object at Step 88.

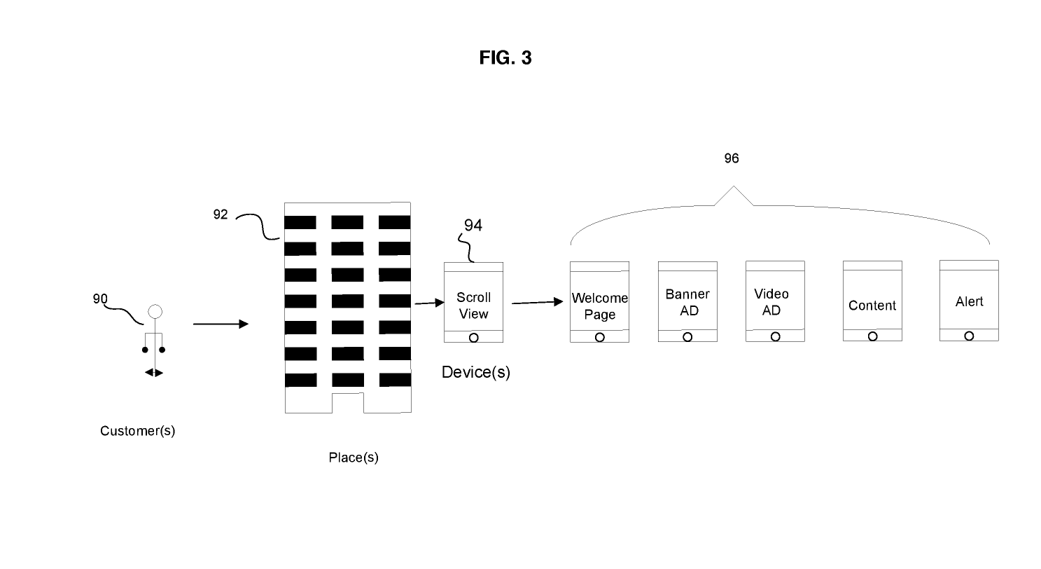

FIG. 3 is a diagram which further illustrates an embodiment outlining the customer interactions and display options available on an interactive device such as a mobile phone (e.g., smart phone), electronic tablet, etc. Customer 90 proceeds to a place of business 92 in which interactive mobile device 94 (smart phone, tablet, etc., containing one or more processors) may be used in connection with shopping. Screen shots 96 show some available viewing choices for a customer. These include a scroll view (during which items may be presented in a scroll down menu), a welcome page, a full page banner or video advertisement (ad), an alert, pop-up, and general content. In some embodiments, an advertisement may appear as a transitional screen between two other screens displayed in connection with running an application program which hereinafter shall be referred to as the AD-Menu app. For example, Ad-Menu may cause the display of a game related advertisement between two menu pages. When an advertisement is displayed as a transitional page, it may be displayed in a mode which allows a user to interact with the ad or proceed through to the next screen to be presented by the AD-Menu in connection with tapping an ad close button. As used herein, the term “banner” refers to a “banner view” for the presentation of an advertising segment, in connection with the operation of the AD-Menu app, for display to a user. Advertisements may appear as a transitional screen between the two other screens displayed by the AD-Menu app. For example, advertisements define an action that takes place when a user sees a banner/video or taps a button on a display. As such, an advertisement could be displayed as an impression or it could launch another application (app) or temporary cover (pop-up). The AD-Menu app presents an interactive advertisement such as a banner or video on which a user may “click” or make touch screen choices. Purchase transactions may occur in connection with a user tapping or clicking a selection on a screen. In an alternative embodiment, full-screen advertising may occur in connection with, for instance, viewing content while using a scroll view. As such, a full-screen ad may appear as a transitional screen between two presentations.

In one embodiment, the advertisements are presented based upon a consumer profile. The consumer profile will consider factors such as age, gender, size of group, menu selections, nationality, and subjective factors. The subjective factors may be supplied to the system by a user where the factors may include observed characteristics of the consumer.

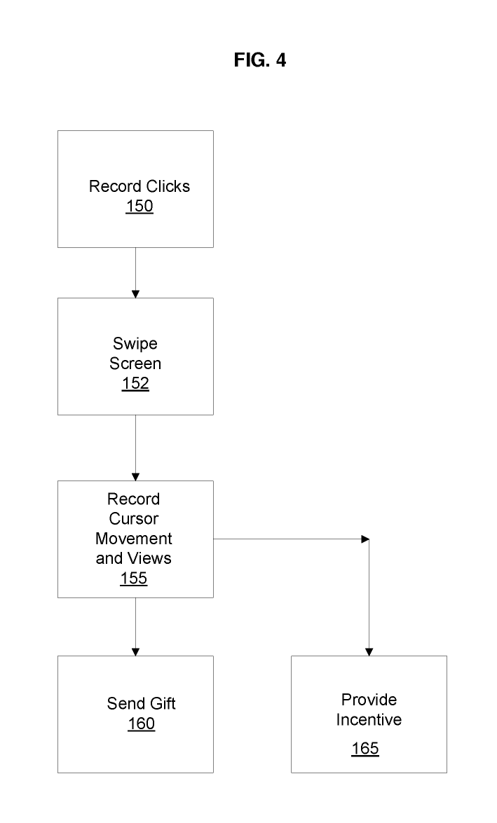

FIG. 4 is a flowchart which outlines further functionality regarding data collection and analysis according to some embodiments. In step 150, in connection with a user making a selection, i.e., clicking on an item, the clicks are recorded to determine the menu choices for a user, and the clicks on advertisements are recorded as well. The recorded information is sent to a repository (not shown) to inform of the user's preferences. Information on the advertisement clicks is also reported to an advertisement database (not shown). The advertisement database also records how many times the advertisement has been shown (impressions) over how many devices. In step 152 the user may swipe the screen for changing advertisements. The advertisements may include 10-30 second videos, and the user may simply click on the advertisement to purchase a product using pay systems within the device, or using a credit card reader. From the advertiser, the restaurant may receive a fee for displaying the ad. Also, the users are profiled based on advertisement preference and the advertisers may receive the profiling information to show advertisements to which the user is receptive. In step 155, cursor movements and views (screen resizing and length of view) are recorded and added to a repository, as well as the advertisement database. It is also contemplated that gifts or other purchases may be sent from one customer of an establishment to another. For instance, as indicated at step 160, the user may send another user a drink. Additionally, a consumer may identify another individual based upon physical location within the building for establishing communication or sending a gift, such as a drink. In an further alternative embodiment, a system according to the foregoing, establishes a physical layout of the location. Additional options are also made possible. For instance, in step 165, a user may be provided with incentives to share an advertisement, including on social networks or by Twitter. In still another embodiment, use of camera(s) and posting of content on social media may also be rewarded, perhaps by discount coupons or further advertising provided in connection with use of an application, system, etc., according to the foregoing.

In one embodiment, the system has a commanding portal wherein a user engages the commanding portal to supply subjective factor information or information regarding specific components of the consumer. The commanding portal authenticates a user through password verification and the user is able to alter functionality of the system. In an alternative embodiment, a consumer portal is available within the system. The consumer portal allows a user to view material provided within the commanding portal as well as information supplied by the system based on algorithmic computation of the various factors related to targeting the consumer for advertisements and menu selections.

In an alternative embodiment, the system is in communication with an automated processing system. The automated processing system receives instruction from the system based on user selection of menu items. The menu item is then prepared to the specifications provided by the user through the system. For example, if the user selects a menu item, such as a beverage, the automated system verifies the details of the menu item and begins preparation of the beverage according to the specification.

In an embodiment, the system engages with point-of-sale (POS) devices. The system communicates with existing POS devices for accounting and inventory regulation. For example, as a consumer selects a menu item the system will update transactional history as well as inventory tracking. The system is configured to provide for redundancies within the facility operation for accuracy and verification of accounting.

In an alternative embodiment, the system communicates with a device configured to verify POS purchases. The system incorporates the multiple factors supplied regarding a consumer and the facility setting. The consumer is then presented with a number of unique advertisements tailored to the specific individual. The tailoring of the specific advertisements is based on the profile factors and subjective factors input through the commanding portal. The consumer then selects an option within the advertisement on the system. The system establishes a secure purchase portal wherein the user enters information such as shipping and billing addresses. The user then engages the device for unique verification. The device may be comprised of a housing and a processor configured to read biological identification factors such as fingerprinting, voice recognition, or photographic authentication. The foregoing functionality may be implemented on a mobile device such as an electronic tablet. The device may also be configured to accept a payment method wherein the device is in communication with the system which is connected to one or more processors, one or more storage media, and one or more payment method reading devices. When payment is confirmed and the user profile is authenticated through the verification within the device, a purchase based on the specific advertisement is completed.

The invention has been described herein using specific embodiments for the purposes of illustration only. It will be readily apparent to one of ordinary skill in the art, however, that the principles of the invention can be embodied in other ways. The foregoing embodiments may be implemented as a program executable by a processor as typically found on a smart phone or electronic tablet device. Information input to a device such as a mobile phone or tablet as described herein, can be received through conventional communication methods such as Wi-Fi, Bluetooth, wireless area networks, etc. received by a receiver by communication methods well known in the art. Therefore, the invention should not be regarded as being limited in scope to the specific embodiments disclosed herein, but instead as being fully commensurate in scope with the following claims.

We claim:

1. A menu advertising system for presenting tailor advertisements to a user comprising:
an electronic device being capable of displaying menu items, the electronic device being further capable of receiving user data in connection with user input to the electronic device;
means, connected to the electronic device, for transmitting user information to a database; and
means for receiving advertisement information, for display on the electronic device, based on an analysis determinative of user preferences.

2. The menu advertising system as recited in claim 1 wherein the user information consists of user browser history, user key strokes, user selections, user purchase information and a combination thereof.

3. The menu advertising system as recited in claim 1 wherein the means for receiving advertisement information includes a wireless communication device having a receiver.

4. A menu advertising system as recited in claim 1 wherein the advertisement information includes a video.

5. A menu advertising system as recited in claim 1 wherein the advertisement information includes an advertising banner.

6. A menu advertising system as recited in claim 5 wherein the advertising banner is for presentation along the edge of a display.

7. A menu advertising system as recited in claim 1, further comprising means for receiving selection choices for purchase.

8. A menu advertising system as recited in claim 7, further comprising means for purchasing a selected menu choice.

9. A method for advertising in connection with using an electronic menu on a portable device, comprising:
maintaining a database of information relating to a user to which the advertisements are intended;
receiving information from the user;
analyzing data received from the user;
selecting tailored information to be sent to the user based on the analyzed data received from the user; and
sending one or more advertisements to the user from selected information based on the analyzed data.

10. The method as recited in claim 9, further comprising:
receiving a response, from the user, to the one or more advertisements and recording additional data in connection with the response.

11. The method as recited in claim 10, further comprising:
updating an analysis of the user based upon browsing and selection history of the user in response to the one or more advertisements.

12. The method as recited in claim 9, further comprising:
receiving biometric data from the user in connection with verifying identity of the user.

13. The method as recited in claim 9 wherein the user is allowed to register for use of the electronic device.

14. The method as recited in claim 9 further comprising receiving an order for purchase of a menu item contained in the tailored information.

15. A computer-readable, non-transitory, programmable product, for use in conjunction with a mobile device, comprising code for causing a processor to do the following:
process database of information relating to a user to which the advertisements are intended;
receive information from the user;
analyze data received from the user;
select tailored information to be sent to the user based on the analyzed data received from the user; and
cause the dispatch of one or more advertisements to the user from selected information based on the analyzed data.

16. A computer-readable, non-transitory, programmable product, as recited in claim 15, for use in conjunction with a mobile device, comprising code for causing a processor to further do the following:
cause the recording of additional information received in connection with a response received from the user to one or more advertisements.

17. A computer-readable, non-transitory, programmable product, as recited in claim 15, for use in conjunction with a mobile device, comprising code for causing a processor to further do the following:
receive an order for purchase of a menu item contained in the tailored information.

18. A computer-readable, non-transitory, programmable product, as recited in claim 15, wherein the mobile device is an electronic tablet.

19. A computer-readable, non-transitory, programmable product, as recited in claim 15, wherein the mobile device is an mobile phone.
